(19) United States
(12) Patent Application Publication
(10) Pub. No.: US 2004/0168470 A1
(43) Pub. Date: Sep. 2, 2004

(54) Method for forming complex ceramic shapes

(76) Inventors: Curtis E. Scott, Mentor, OH (US); Douglas G. Seredich, Montville, OH (US); Daniel Polis, Takoma Park, MD (US); Vishal Gauri, San Jose, CA (US); Karthik Sivaraman, Mayfield Village, OH (US)

Correspondence Address: Timothy E Nauman, Fay Sharpe Fagan Minnich & McKee, 7th Floor, 1100 Superior Avenue, Cleveland, OH, 44114-2518, US

(21) Appl. No.: 10/451,054

(22) PCT Filed: Dec. 19, 2001
(86) PCT No.: PCT/US01/49420

Related U.S. Application Data
(60) Provisional application No. 60/256,655, filed on Dec. 19, 2000.

(51) Int. Cl. C03B 8/00

(52) U.S. Cl. 65/17.2; 445/22; 445/26

(57) ABSTRACT

A method for forming single element arc tubes is provided. The method includes the use of the lost foam process in combination with ceramic forming processes. First, a polymeric material (20) is formed to define the internal dimensions. The outer dimensions are established with an external mold (40), followed by filling the mold with a suspension (60) that hardens. The outer mold is removed and the part is debindered to melt and remove the inner foam shape, followed by sintering to form a substantially transparent ceramic arc tube (70).

### BACKGROUND OF THE INVENTION

1. Field of the Invention

This application claims priority from U.S. provisional application Serial No. 60/256,655, filed Dec. 19, 2000.

The present invention relates to ceramic components and methods of forming same, and more particularly to ceramic arc tubes used in ceramic metal halide (CMH) lamps.

2. Discussion of the Art

Discharge lamps produce light by ionizing a fill material such as a mixture of metal halides and mercury with an arc passing between two electrodes. The electrodes and the fill material are sealed within a translucent or transparent discharge chamber or arc tube which maintains the pressure of the energized fill material and allows the emitted light to pass through it. The fill material, also known as a “dose”, emits a desired spectral energy distribution in response to being excited by the electric arc. For example, halides provide spectral energy distributions that offer a broad choice of light properties.

Ceramic discharge lamp chambers were developed to operate at higher temperatures, i.e., above 950° C., for improved color temperatures, color renderings, and luminous efficacies, while significantly reducing reactions with the fill material. Typically, ceramic discharge chambers are constructed from a number of components which are extruded or die-pressed from a ceramic powder. Commonly owned, co-pending applications U.S. Ser. No. 09/067,816, filed Apr. 28, 1998, and U.S. Ser. No. 09/250,634, filed Feb. 16, 1999, describe one type of conventional ceramic discharge chamber which minimizes the number of joints used in forming the discharge chamber. For example, prior practice employed a five component construction including a central cylinder substantially closed at either end by first and second end plugs. Separate first and second legs were separately joined to respective end plugs. The referenced applications are directed to assemblies that use as few as two components to form the discharge chamber. Commonly owned, co-pending application U.S. Ser. No. 09/471,551, filed Dec. 23, 1999, limits the number of components in an arc chamber by integrally forming the legs in one body component. A lens is integrated into the other body component to increase the lumens distribution since there is no leg to interfere with radiation from the chamber.

As is described in the referenced co-pending applications, limiting the number of components in the arc tubes, and likewise the number of joints, results in desired efficiencies and reduced manufacturing costs. Thus, eliminating manufacturing steps, components, and achieving improvements in the conductive and radiative heat losses with higher lamp efficacy are all desired features. Similarly, attaining better control of arc gap length results in flicker-free operation, more reliable starting, more stable operation, and increased lamp efficacy and color performance.

While the methods and manufacturing processes are used to effectively control the exterior or outer surface shape of the arc tubes, they do not adequately address the internal dimensions needed for what is perceived to be the next generation of discharge lamps. These lamps are envisioned to have more complex shapes and configurations, and will require more sophisticated manufacturing techniques to accommodate these shapes. Thus, while substantial strides have been made in reducing the number of components in CMH lamps, the ability of forming complex shapes has not been improved. It is therefore desirable to develop a method for forming complex single element ceramic arc tubes, particularly with increased control over the interior configuration of the arc tubes.

### BRIEF SUMMARY OF THE INVENTION

The present invention relates to a method for forming single element arc tubes. First, a form preferably formed of a carbonaceous form, is created and has an external profile that defines desired internal dimensions of the arc tube. Alternatively, the form may be metallic. Outer dimensions of the arc tube are then established with an external or outer mold received about the form, followed by filling the outer mold with a suspension which will subsequently harden. Lastly, the outer mold is removed and the part is debindered to remove the inner form.

One advantage of this invention is the ability to form complex single element arc tubes.

Another advantage of the present invention is the ability to achieve greater control of the interior shape of the ceramic arc tube.

### BRIEF DESCRIPTION OF THE DRAWINGS

FIGS. 1-4 are schematic views of sequential forming steps depicting the inventive method.

FIG. 5 is a schematic drawing of one possible arc tube design of the present invention.

### DETAILED DESCRIPTION OF THE INVENTION

The present invention relates to a method for the formation of single element complex ceramic arc tubes, hereinafter “arc tubes.” The arc tubes of the present invention are formed by a unique combination of a “lost foam process” and ceramic forming processes.

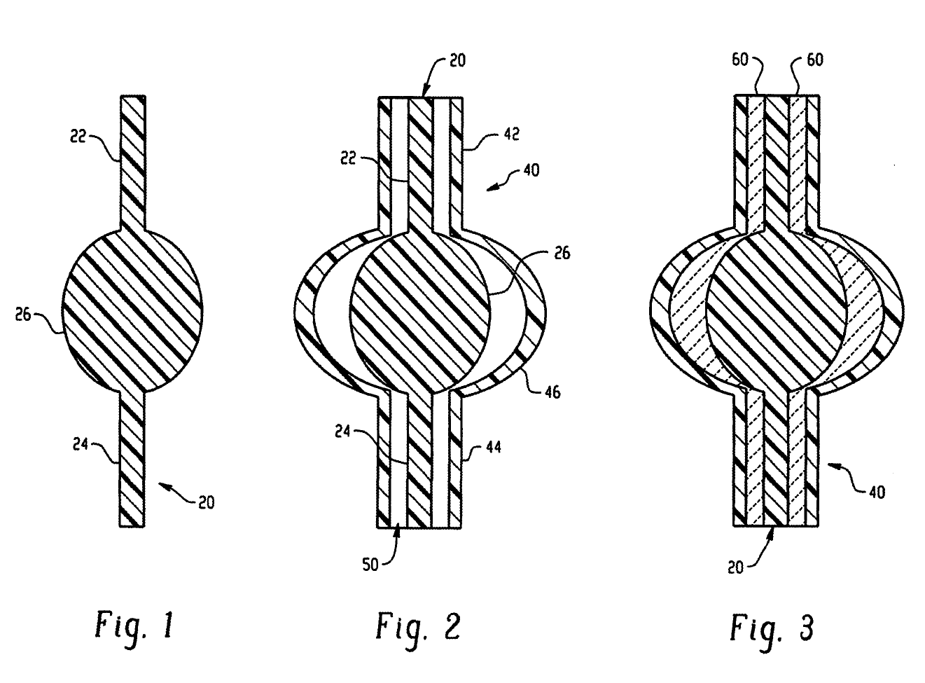

As depicted in FIG. 1, a form 20 is fabricated. Preferably the form is a porous polymeric material, although the invention should not be limited to the particular material used to create the form. For example, the form may be graphite, a graphite/polymer composite, or other low molecular weight solids which are not polymers. In addition, the form can also be metallic, such as a bismuth based alloy, which has a melting point less than about 100° C. The form 20 is fabricated from suitable materials which may be readily combustible or can be melted without leaving any residue, or any significant residue, but which may also be shaped far more expeditiously than conventional pattern materials. The form may adopt most desired configurations by conventional hand or machine shaping and, whenever more convenient, may be fabricated from a number of separate components that are readily secured to each other by simple cementing, doweling, or wiring. The form 20 is preferably fabricated from relatively inexpensive, expanded plastics, such as polystyrene or polyethylene. Any form known in the art as useful in a lost foam process is contemplated by the present invention.

The form has a general shape of first and second legs 22, 24 extending from a central body 26 having a generally ellipsoidal shape. In a preferred embodiment, the legs of the form are defined by solid pins that have inner ends inserted into the central body portion. The pins/legs are mechanically removed from the central body as part of the inner form removal step to be described below. Alternatively, the legs are integrally formed with the central body and thus removed in the same manner as the remainder of the inner form 20. It will be appreciated, however, that the configurations of the body and legs can adopt a variety or conformations in light of the advantages offered by the present invention.

After the form is complete, it is placed inside an outer or external mold 40 (FIG. 2). This mold is similar to molds used for traditional arc tube formation, such as gel casting, coagulation casting, or injection molding. This outer mold 40 is used to control the exterior outer surface shape of the arc tube. Preferably, the external mold 40 is formed of multiple, mating components such as first and second halves that are selectively opened to insert the inner form 20. Again, the outer mold 40 adopts the general configuration of hollow first and second legs 42, 44 that are dimensioned for receipt over respective legs 22, 24 of the form. Likewise, a central portion 46 is received in spaced relation around the body 26 of the form. In this manner, a cavity 50 is defined between the form 20 and the body 40 once the mating components of the external mold are enclosed about the form.

After both the outer mold 40 and the inner mold 20 have been formed and fitted together, an oxide suspension 60 is introduced between them as illustrated in FIG. 3. The oxide suspension 60 is preferably poured, as in gel casting, or injected as per injection molding, into the mold. The suspension 60 fills the cavity and conforms to the exterior and interior contours of the form and outer mold, respectively. The suspension 60 is hardened or cured by methods known in the sol gel and injection molding art to form a ceramic arc tube. The outer mold 40 is subsequently removed as represented in FIG. 4.

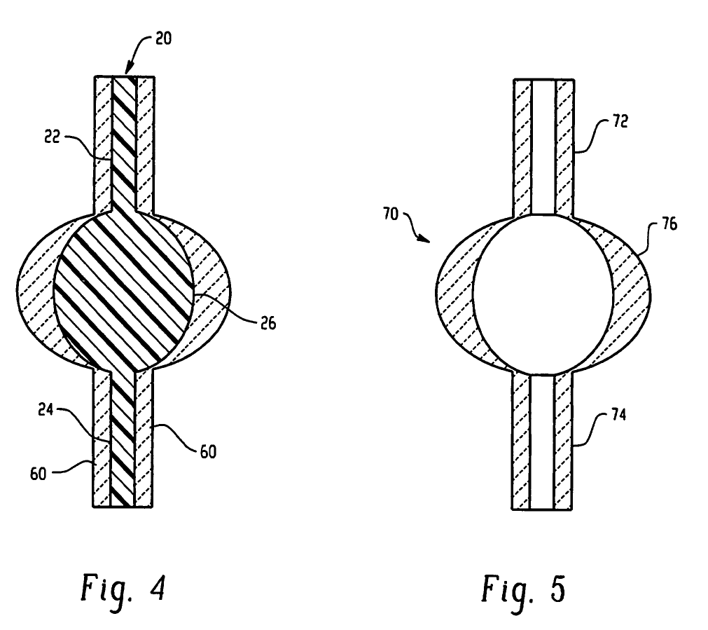

After the removal of the outer mold, the ceramic arc tube 70 and the inner form 20 are debindered and presintered. This processing step serves to remove the inner form 20 by melting or dissolving it (compare FIGS. 4 and 5). The inner form and all other organic and processing materials are advantageously removed from the interior. The newly formed arc tube 70 and inner form 20 are debindered and presintered in air from room temperature to a maximum temperature of about 900-1100° C. over 4-8 hours, then holding the maximum temperature for about 1-5 hours, and then subsequently cooled. As will be appreciated, the arc tube 70 has first and second hollow legs 72, 74 extending from opposite ends of a central body 76. The orientation and shape of the individual components of the integral arc tube can adopt a wide variety of configurations.

Alternatively, the inner form 20 can be removed before debindering the newly formed arc tube 70. In this method, the inner form 20 is removed by a variety of methods known in the lost foam art, followed by debindering of the newly formed arc tube 70 in air from room temperature to a maximum temperature of about 900-1100° C. over 4-8 hours.

It is also contemplated that debinding of a majority of the form may occur at room temperature, for example, followed by a thermal cycle to remove the core. This reverse procedure of debinding the outer mold and subsequently removing the inner core has distinct advantages in certain situations.

After debindering and presintering, the ceramic arc tube 70 of FIG. 5 is preferably sintered in a hydrogen atmosphere at a temperature greater than 1500° C., in accordance with the preferred embodiment between about 1600 and 2000° C., and most preferably between about 1800 and 1900° C. This sintering step results in ceramic arc tubes which are at least substantially transparent.

The resultant arc tube is a hollow ceramic arc tube having complex inner and outer contours, that finds application in high pressure discharge lamps. The arc tube preferably comprises alumina (Al₂O₃) having a purity of about 99.98% and a surface area of about 2-10 m²/g before sintering. The alumina powder can be doped with magnesia to inhibit grain growth, for example in an amount equal to about 0.03-0.2%, preferably about 0.05% by weight of the alumina. Other ceramic materials which may be used include non-reactive refractory oxides and oxynitrides, such as yttrium oxide, lutecium oxide, and hafnium oxide, and their solid solutions and compounds with alumina, such as yttrium-aluminum-garnet and alumina oxynitride. Binders which may be used individually or in combination include organic polymers such as polyols, polyvinyl alcohol, vinyl acetates, acrylates, cellulosics, and polyesters.

According to one exemplary method of construction, the component parts of the discharge chamber are formed by injection molding a mixture comprising about 45-60% by volume ceramic material and about 55-40% binder in the mold formed by the combination of the inner form 20 and the outer form 40. The ceramic material can comprise an alumina powder having a surface area of about 1.5 to about 30 m²/g, typically between about 3-5 m²/g. According to one embodiment, the alumina powder has a purity of at least 99.98%. The alumina powder may be doped with magnesia to inhibit grain growth, for example in an amount equal to about 0.03-0.2%, preferably 0.05%, by weight of the alumina.

The binder preferably comprises a wax mixture or a polymer mixture. According to one example the binder comprises:

33⅓ parts by weight paraffin wax, melting point 52-58° C.;

33⅓ parts by weight paraffin wax, melting point 59-63° C.; and

33⅓ parts by weight paraffin wax, melting point 73-80° C.

The following substances are added to the 100 parts by weight paraffin wax:

4 parts by weight white beeswax;

8 parts by weight oleic acid; and

3 parts by weight aluminum stearate.

The above paraffin waxes are available from Aldrich Chemical, under Product Numbers 317659, 327212, and 411671, respectively, although it will be appreciated that other suitable binders may be used without departing from the scope and intent of the present invention.

In the process of injection molding, the mixture of ceramic material and binder is heated to form a high viscosity mixture. The mixture is then injected into a suitably shaped mold and subsequently cooled to form a molded part. Subsequent to injection molding, the binder and inner form 20 are removed from the molded part, typically by thermal treatment, to form a debindered component. The thermal treatment is conducted in accordance with the preferred arrangement by heating the molded part in air or a controlled environment, e.g., vacuum, nitrogen, rare gas, to a maximum temperature. For example, the temperature is slowly increased by about 2-3° C. per hour from room temperature to a temperature of 160° C. Next, the temperature is increased by about 100° C. per hour to a maximum temperature of about 900-1100° C. Finally, the temperature is held at about 900-1100° C. for about 1-5 hours. The part is subsequently cooled. After the thermal treatment step the porosity is about 40-50%.

The resulting ceramic arc tube 70 is a single element arc tube which has a complex shape. It is desirable to reduce the number of components that comprise the discharge chamber to reduce the number of bonds between the components. This has the advantage of expediting assembly of the discharge chamber and reducing the number of potential bond defects during manufacture, as well as reducing the possibility of failure of the discharge chamber at a bond region during handling. The present invention eliminates the necessity of binding together separate ceramic components to form a complex shape. The combination of the lost foam process as described above with ceramic forming processes therefore eliminates costly steps and the need for extra materials in the arc tube.

The arc tube of the present invention finds applications in high pressure discharge lighting applications. High pressure discharge lamps generally comprise a ceramic housing (arc tube) having a chamber adapted to receive a fill which is sealingly encapsulated in the discharge chamber. First and second electrodes are disposed in spaced relation in the chamber to produce an arc in response to an electrical potential applied across the electrodes. The electrodes are connected to conductors to apply a potential difference across the electrodes in a manner well known in the art. In operation, the electrodes produce an arc which ionizes the fill material to produce a plasma in the discharge chamber. For a ceramic metal halide lamp, the fill material typically includes a mixture of Hg, a rare gas such as Ar or Xe, and a metal halide such as NaI, TlI, or DyI₃. Other examples of fill materials are well known in the art.

The invention has been described with reference to the exemplary embodiments. Modifications and alterations will occur to others upon reading and understanding the specification. In one preferred example, a machined graphite core was used, an alumina suspension having a formulation similar to that dislcosed in U.S. Pat. No. 5,145,908 was gelcast about the core, the alumina debindered at room temperature, the core degraded at an elevated temperature on the order of 600° C., and the envelope then sintered to produce a translucent envelope. The invention though is not to be limited to any one example but is intended to include modifications and alterations insofar as they come within the scope of the disclosure.

What is claimed is:

1. A method of forming a single element arc tube (70) for a ceramic metal halide lamp comprising the steps of:
providing an inner form (20) having an external conformation that matches a desired internal dimensions of an arc tube;
providing an outer form (40) around the inner form and defining a cavity (50) therebetween;
filling the cavity with a suspension (60) that subsequently hardens; and
removing the inner and outer forms.

2. The method of claim 1 wherein the removing step includes the step of debindering the hardened suspension.

3. The method of claim 1 wherein the inner form providing step includes using a graphite material for the inner form.

4. The method of claim 1 wherein the inner form providing step includes using a graphite/polymer composite material for the inner form.

5. The method of claim 1 wherein the inner form providing step includes using a non-polymeric low molecular weight solids material for the inner form.

6. The method of claim 1 wherein the inner form providing step includes using a metallic material for the inner form.

7. The method of claim 6 wherein the inner form providing step includes using a bismuth based alloy material for the inner form.

8. The method of claim 7 wherein the inner form providing step includes using a bismuth based alloy material having a melting point less than about 100° C. for the form.

9. The method of claim 1 wherein the inner form providing step includes shaping the form (20) to include first and second legs (22, 24) extending from a body (26) having a generally ellipsoidal conformation.

10. The method of claim 1 wherein the outer form providing step includes using mating outer form components for the outer form.

11. The method of claim 1 wherein the cavity filling step includes introducing an oxide suspension (60) into the cavity.

12. The method of claim 1 further comprising the step of curing the suspension before the removing step.

13. The method of claim 1 further comprising the steps of debindering and then presintering.

14. The method of claim 13 wherein the presintering and debindering steps occur after the outer form removing step.

15. The method of claim 13 comprising the further step of sintering the hardened suspension after the presintering and debindering steps.

16. The method of claim 1 wherein the method includes debindering the outer suspension before removing the inner form, and then presintering the hardened suspension.

17. The method of claim 1 wherein the method includes removing the inner form before debindering the outer suspension, and then presintering the hardened suspension.

18. The method of claim 1 wherein the inner removing form step includes the step of dissolving the inner form from the hardened suspension.

19. The method of claim 1 wherein the cavity filling step includes injection molding a ceramic material/binder into the cavity.

20. A ceramic arc tube formed by a process including the steps of:
providing an inner core (20) formed of a carbonaceous material having an external conformation that matches desired internal dimensions of the arc tube;
gelcasting an alumina suspension around the core;
debindering the alumina suspension;
degrading the inner core at an elevated temperature; and
sintering the arc tube.

21. The ceramic arc tube of claim 20 comprising the further step of presintering the alumina suspension before the sintering step.

22. The ceramic arc tube of claim 20 wherein the inner core degrading step is performed subsequent to the debindering step.

23. The ceramic arc tube of claim 20 wherein the inner core degrading step is performed before the debindering step.
